(19) United States
(12) Patent Application Publication
(10) Pub. No.: US 2006/0095503 A1
(43) Pub. Date: May 4, 2006

(54) Information processor, mobile terminal, information processing system, information processing method, information processing program, and computer-readable recorded medium

(76) Inventor: Hiroyuki Kanza, Kyoto (JP)

Correspondence Address: BIRCH STEWART KOLASCH & BIRCH, PO BOX 747, FALLS CHURCH, VA, 22040-0747, US

(21) Appl. No.: 10/540,877

(22) PCT Filed: Dec. 22, 2003
(86) PCT No.: PCT/JP03/16418

§ 371 Date: Jun. 27, 2005

(30) Foreign Application Priority Data
Dec. 26, 2002 (JP) 2002-376610

(51) Int. Cl. G06F 15/16

(52) U.S. Cl. 709/203

(57) ABSTRACT

In an information processor, a situation and operation storage section stores situation information, acquired by a situation acquiring section, about a situation in which an operation has been performed and operation information, received from an operation section, about the operation in an associated manner. A situation comparing section compares a current situation information piece with situation information pieces stored in the situation operation storage section. Based on situation information pieces stored in hierarchical structure in a situation hierarchy storage section, a broader concept common to two situation information pieces compared by the situation comparing section is searched for. If the broader concept of the current situation information piece agrees with that of a stored situation information piece, an operation adapting section adapts an operation procedure corresponding to stored operation information piece to the current situation, and a presentation selecting section executes the operation procedure.

### TECHNICAL FIELD

The present invention relates to an information processor, a portable terminal, an information processing system, an information processing method, an information processing program and a computer-readable recording medium, and relates, in particular, to an information processor, a portable terminal, an information processing system, an information processing method, an information processing program that are adapted to determine a situation and predicts a highly possible function to be executed under the situation, and a computer-readable recording medium containing the program.

### BACKGROUND ART

Conventional information processors include one that determines a situation and predicts a function to be executed under the situation (refer to, for example, JP 11-15876 A). The information processor stores whereabouts and how operations have been executed as pieces of history information and when the history information includes a piece that agrees with the present position or close to it, the information processor executes corresponding operation. Further, even when information about the place or the environment is not included in the history information, the information processor enables operation by utilizing place category information held in association with position information.

For example, let us consider a case where a user is currently located at a place expressed by the longitude and latitude of (135.41, 35.43) and there is stored historical information representing that specific mails have been sent several times at a place expressed by (135.43, 35.43). If the information representative of the association between the position information and the place category states that the places of (135.41, 35.43) and (133.43, 35.43) are both located at movie theaters, a specific mail can be transmitted since the present position and the position of the historical information, which are not the same, agree in the place category.

It is normally necessary to perform a procedure having a plurality of steps to make an apparatus to perform a function. For example, when sending a mail, the procedure includes steps of selecting a mail function, inputting a mailing address, inputting a title, inputting a text, and sending the mail. Since such a procedure is troublesome to a user who always does the same operation at like places, the information processor is beneficial with improved convenience.

However, since the category of places is not hierarchized in the information processor, it is only permitted to determine whether or not the places belong to an identical category. This therefore has a problem that the information processor is unable to render prioritization when there are a plurality of candidates and unable to determine which candidate should be presented to the user.

Moreover, because the categorized objects are limited to the position information, the information processor has a problem that an appropriate procedure cannot be presented with regard to situations other than the position. For example, since time information is not categorized, performing a prescribed processing in a certain time period is impossible.

The information processor has a further problem that processings to be executed when the position information is different but the place categories are the same would be disadvantageously identical. For example, when a person, who often sees the timetable at B station, is presently located at A station, the same processing as that of the B station is to be executed at the A station because of the common category of “station”, and consequently the timetable of the B station is disadvantageously displayed at the A station.

Furthermore, the information processor, which manages the position information on the basis of the geographic position expressed by the latitude and the longitude and so on, needs a sensor of GPS or the like. This causes a problem of high cost and a technical restriction that the position information is hard to obtain in an underground shopping center or the like as well as a problem of accuracy of the sensor of GPS or the like.

### SUMMARY OF THE INVENTION

It is a first object of the present invention to provide an information processor capable of accurately predicting an operation necessary for a current situation and performing an operation according to the situation in a simple procedure.

A second object of the present invention is to provide the information processor further capable of performing operations according to respective situations even if the situations belong to the same category.

A third object of the present invention is to provide the information processor further capable of utilizing information on positions without employing any special device.

In order to accomplish the above objects, an information processor according to the present invention includes:

a situation acquiring means for acquiring situation information about a situation in which an operation has been performed;

a situation and operation storage means for storing the situation information acquired by the situation acquiring means and operation information about the operation performed then in an associated manner;

a situation comparing means for comparing a current situation information piece with situation information pieces stored in the situation and operation storage means;

a situation hierarchy storage means for storing at least the situation information acquired by the situation acquiring means in a hierarchical structure;

a broader concept searching means for searching for a broader concept common to two situation information pieces compared by the situation comparing means on a basis of the situation information of the hierarchical structure stored in the situation hierarchy storage means; and

an operation procedure executing means for executing an operation procedure according to an operation information piece stored in the situation and operation storage means on a basis of a result of the comparison by the situation comparing means and a result of the search by the broader concept searching means.

The “situation information” herein represents the place where an operation has been performed, time, climatic conditions, user's work contents, user's psychological conditions, and the type, state and so on of the connected apparatus. The “operation information” represents overall apparatus operations such as, for example, “sending a mail”, “Web browsing”, “inputting a schedule” and “watching television”. Moreover, the operation information also includes target-specified operations like “sending a mail to Mr. A” and “browsing the home page of B company”.

In the information processor of the present invention, the situation information and the operation information are stored in an associated manner in the situation and operation storage means, and an operation performed under a past similar situation is executed by an easy method. At this time, the determination as to the similarity of the situations is made by storing in the situation hierarchical storage means at least situation information pieces acquired by the situation acquiring means pieces as a hierarchical structure and examining by the situation comparing means and the broader concept searching means whether or not the current situation information agrees in the broader concept with any situation information piece stored in the situation and operation storage means. Then, on the basis of the comparing result of the situation comparing means and the search result of the broader concept searching means, the operation procedure executing means executes the operation procedure according to the operation information stored in the situation and operation storage means. Therefore, opportunities to utilize past operations are increased, and the user, who has a routine to be performed under the same situation, can execute a desired operation through a simple procedure without carrying out a plurality of troublesome operations.

In one embodiment, the information processor has an operation adapting means for adapting an operation procedure to be executed by the operation procedure executing means to a current situation when as a result of the search by the broader concept searching means, a broader concept of a situation information piece on the current situation agrees with that of a situation information piece stored in the situation and operation storage means.

The term “adapting” or “adaptation” herein means modifying or changing part of the stored operation adaptively to the situation. For example, when a person, who often sees the timetable at B station, is located at A station, the timetable of the A station is displayed substituting for the timetable of the B station on the basis of the operation of seeing the timetable of the B station performed at the B station in the past. This increases chances to provide a better response in accordance with the situation.

In one embodiment, the information processor has a communication means for communicating with apparatuses that have their respective unique addresses, and the situation acquiring means acquires a unique address of an apparatus targeted for communications as a constituent element of the situation information via the communication means.

The “unique address” of an apparatus includes, for example, an IP (Internet Protocol) address.

In the embodiment, the IP address of an apparatus connected to a network is acquired as one element or piece of the situation information by the situation acquiring means via the communication means. For example, if the IP address of an apparatus at an access point is acquired and stored when hooking up to the Internet by using a wireless LAN or the like at a certain outdoor place, the stored IP address can be determined as past situation information when hooking up to the Internet at the same place at another opportunity. The IP address allocated to the apparatus at the access point is effective for identifying the place.

With this arrangement, the information relevant to the place can be utilized even when a special device for acquiring the position information, such as GPS, is not utilized, and a desired operation can be executed by a simple procedure at the same place where a similar operation was performed in the past.

When the unique address of the apparatus targeted for communications has been allocated by a server, the situation acquiring means may preferably acquire an IP address of the server via the communication means.

Also, the information processor may, preferably, include a situation and operation inputting means for specifying, by a user, situation information and operation information to be stored in the situation and operation storage means.

A portable terminal according to the present invention has the information processor as described above.

An information processing system according to the present invention has a server and a portable terminal to communicate with the server, wherein

the portable terminal has:
a situation acquiring means for acquiring situation information about a situation in which an operation has been performed;
a situation and operation storage means for storing the situation information acquired by the situation acquiring means and operation information about the operation performed then in an associated manner;
a situation comparing means for comparing a current situation information piece with situation information pieces stored in the situation and operation storage means; and
an operation procedure executing means for executing an operation procedure according to an operation information piece stored in the situation and operation storage means on a basis of a result of the comparison by the situation comparing means, and

the server has:
a situation hierarchy storage means for storing the situation information acquired by the situation acquiring means in a hierarchical structure; and
a broader concept searching means for searching for a broader concept common to two situation information pieces compared by the situation comparing means on a basis of the situation information of the hierarchical structure stored in the situation hierarchy storage means.

With the above arrangement, opportunities to utilize past operations are increased, and the user, who has a routine to be performed under the same situation, can execute a desired operation through a simple procedure without carrying out a plurality of troublesome operations.

Also, an information processing method according to the present invention has:

a situation acquiring step of acquiring a situation information piece about a situation in which an operation has been performed;

a situation and operation storage step of storing the situation information piece acquired in the situation acquiring step and an operation information piece about the operation performed in an associated manner;

a situation comparing step of comparing a current situation information piece with situation information pieces stored in the situation and operation storage step;

an operation procedure executing step of executing an operation procedure according to an operation information piece stored at the situation and operation storage step on a basis of a result of the comparison done in the situation comparing step;

a situation hierarchy storage step of storing the situation information pieces acquired by the situation acquiring means in a hierarchical structure;

a broader concept searching step of searching for a broader concept common to two situation information pieces compared in the situation comparing step on a basis of the situation information of the hierarchical structure stored in the situation hierarchy storage step.

By using the above information processing method, opportunities to utilize past operations are increased, and the user, who has a routine to be performed under the same situation, can execute a desired operation through a simple procedure without carrying out a plurality of troublesome operations.

An information processing program according to the present invention is a program for enabling a computer to execute the above information processing method.

By a computer carrying out the above information processing method by means of the above information processing program, opportunities to utilize past operations are increased, and the user, who has a routine to be performed under the same situation, can execute a desired operation through a simple procedure without carrying out a plurality of troublesome operations.

A computer-readable recording medium according to the present invention contains the above information processing program.

By a computer loading the information processing program recorded in the computer-readable recording medium and executing the information processing method, opportunities to utilize past operations are increased, and the user, who has a routine to be performed under the same situation, can execute a desired operation through a simple procedure without carrying out a plurality of troublesome operations.

### BRIEF DESCRIPTION OF THE DRAWINGS

FIG. 1 is a block diagram showing the construction of an information processor according to one embodiment of the present invention;

FIG. 2 is a diagram in which a situation hierarchy storage section of the information processor is schematized;

FIG. 3 is a diagram in which a situation hierarchy storage section of the information processor is schematized;

FIG. 4 is a flow chart showing the operation of the information processor;

FIG. 5 is a flow chart showing the processing in a situation comparing section of the information processor;

FIG. 6 is a flow chart showing the processing in an operation adapting section of the information processor;

FIG. 7 is a diagram showing a processing example of an information processor with a fundamental construction for comparison;

FIG. 8 is a diagram showing a processing example of the information processor with the fundamental construction for comparison;

FIG. 9 is a diagram showing a processing example of an information processor according to one embodiment of the present invention;

FIG. 10 is a diagram showing registered information contained in the operation adapting section of the information processor;

FIG. 11 is a diagram showing registered information contained in the operation adapting section of the information processor; and

FIG. 12 is a block diagram of the information processor with the fundamental construction for comparison.

### DETAILED DESCRIPTION OF THE INVENTION

The information processor, portable terminal, information processing system, information processing method, information processing program and computer-readable recording medium of the present invention will be described in detail below on the basis of embodiments shown in the drawings.

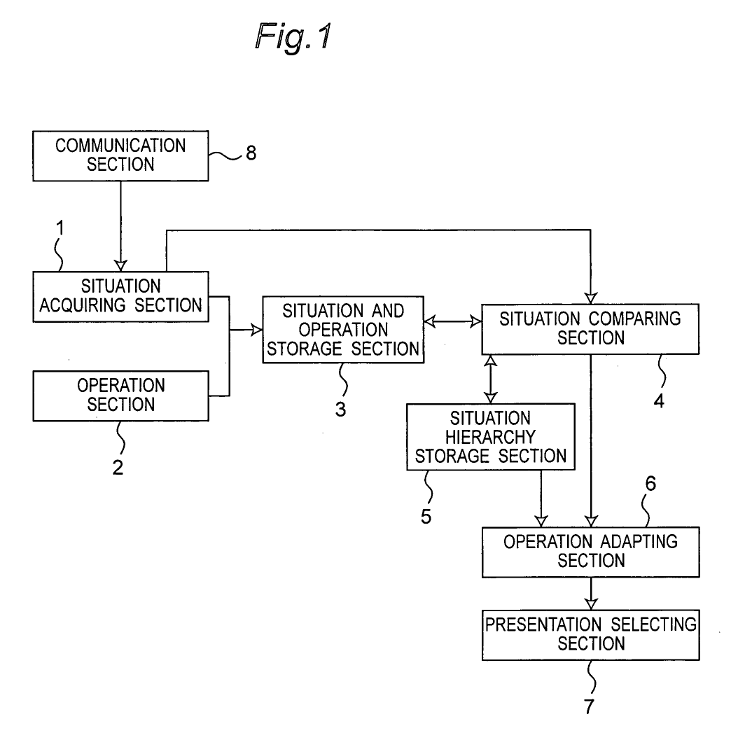

FIG. 1 is a block diagram showing the construction of an information processor according to one embodiment of the present invention. The information processor includes a situation acquiring section 1 as one example of the situation acquiring means, an operation section 2 as one example of the situation and operation inputting means, a situation and operation storage section 3 as one example of the situation and operation storage means, a situation comparing section 4 as one example of the situation comparing means, a situation hierarchy storage section 5 as one example of the situation hierarchy storage means and the broader concept searching means, an operation adapting section 6 as one example of the operation adapting means, a presentation selecting section 7 as one example of the operation procedure executing means and a communication section 8 as one example of the communication means.

The situation acquiring section 1 is a means for acquiring a current situation information as to the place where an operation has been performed, the time, climatic conditions, the user's work contents, the user's psychological conditions, the type and status of a connected apparatus, etc.

For example, information on the “place where the operation has been performed” can be acquired using GPS (Global Positioning System). According to the GPS, position information can be expressed by longitude and latitude. Moreover, the acquisition of “time” can be achieved by a clock built in an apparatus, a radio wave clock or the like. Moreover, the “climatic conditions” can be acquired by using sensors for measuring the temperature and/or humidity, and/or weather forecast information on the Web interlinked with the position information of GPS. Moreover, the “user's work contents” can be acquired by observing the state of the apparatus being presently used. Moreover, the “user's psychological conditions” are acquired by using sensors of bodily temperature, pulse frequency and so on. Further, the “type and status of a connected apparatus” can be acquired by tracing various procedures for establishing network connection.

Although methods of acquiring the situation information pieces have been described above, the situation information pieces and the acquisition methods are not limited to the described ones.

The operation section 2 is a means through which the user performs operations such as “push a button”, “input characters”, “select an item from a menu”, etc.

The situation and operation storage section 3 is a means for storing situation information pieces received from the situation acquiring section 1 and operation information pieces received from the operation section 2 in pairs. This storage section stores what sort of operation has been performed on what circumstances, indicating that such and such an operation has been done at such and such a time in such and such a place.

The situation comparing section 4 is a means for comparing the current situation with the situation information stored in the situation and operation storage section 3 and finding, from among the situation information pieces stored therein, a situation information piece agreeing with the current situation to thereby find an associated operation.

The situation hierarchy storage section 5 is a means for storing the situation information pieces expressed in the form of a tree structure of broader concepts to narrower concepts, and obtaining a broader concept common to two situation information pieces to be matched with each other in the situation comparing section 4 on the basis of the stored hierarchical structure situation information. It should be noted that situation information to be stored in the situation hierarchy storage section 5 includes situation information pieces acquired by the situation acquiring section 1 during the operation and information pieces set by the user with the operation section 2.

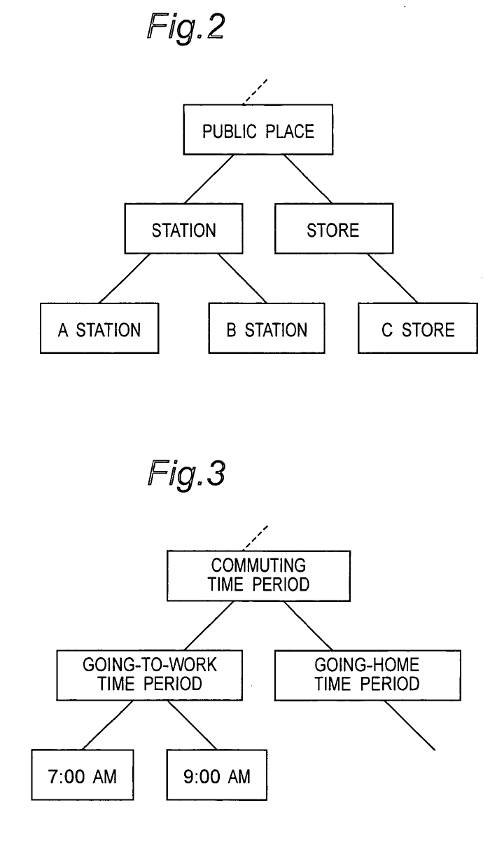

FIG. 2 shows an example of a tree structure of places, and FIG. 3 shows an example of a tree structure of times. Referring to FIG. 2, a concept “public place” has narrower concepts of “station” and “store”, the concept “station” has also narrower concepts of “A station” and “B station”, and the concept “store” has a narrower concept of “C store”. On the other hand, in FIG. 3, a concept “commuting time period” has narrower concepts of “going-to-work time period” and “going-home time period”, and the concept “going-to-work time period” has narrower concepts of “7:00 am” and “9:00 am”.

The operation adapting section 6 shown in FIG. 1 is a means for, when the current situation information agrees with situation information stored in the situation and operation storage section 3 in their broader concept, adapting an operation procedure according to operation information stored in association with the found situation information to the situation at the time.

The presentation selecting section 7 is a means for presenting to the user operations that have possibilities of being executed in the current situation and allowing the user to select a desired operation from among them. The presentation of the possible operations is performed with the aid of an output device (not shown). Generally, the output device may be constructed of, for example, a display such as an LCD, although when the presentation is to be vocally performed, the output device is constructed of a speaker. Moreover, the selection by the user is performed with an input device (not shown). The input device may be constructed of, for example, a keyboard, a button, a mouse pointer, a tablet, a microphone or the like.

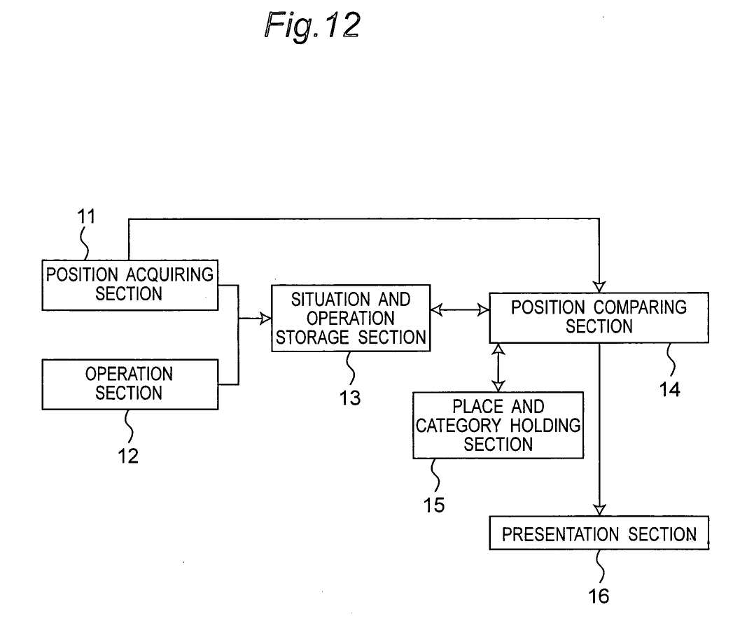

Next, FIG. 12 is a block diagram showing the fundamental construction of an information processor for plainly explaining the information processor of the present invention. Differences in construction between the information processor shown in FIG. 12 and the information processor of the present invention will be described below.

A position acquiring section 11 shown in FIG. 12 is a means for acquiring information on a position where the user is located. A first difference resides in that the information processor of the present invention has a situation acquiring means for acquiring situation information including position information.

Moreover, a place category holding section 15 shown in FIG. 12 is a means for storing positions along with respective place category information pieces, while in the information processor of the present invention, the situation information is stored as a hierarchical structure in the situation hierarchy storage section 5. This is a second difference.

Moreover, the information processor of the present invention has the operation adapting section 6, but such a section does not exist in the information processor shown in FIG. 12. This is a third difference.

It is to be noted that an operation section 12, a situation and operation storage section 13, a position comparing section 14 and a presentation selecting section 16 of the information processor shown in FIG. 12 are the same as the corresponding sections of the embodiment of the present invention.

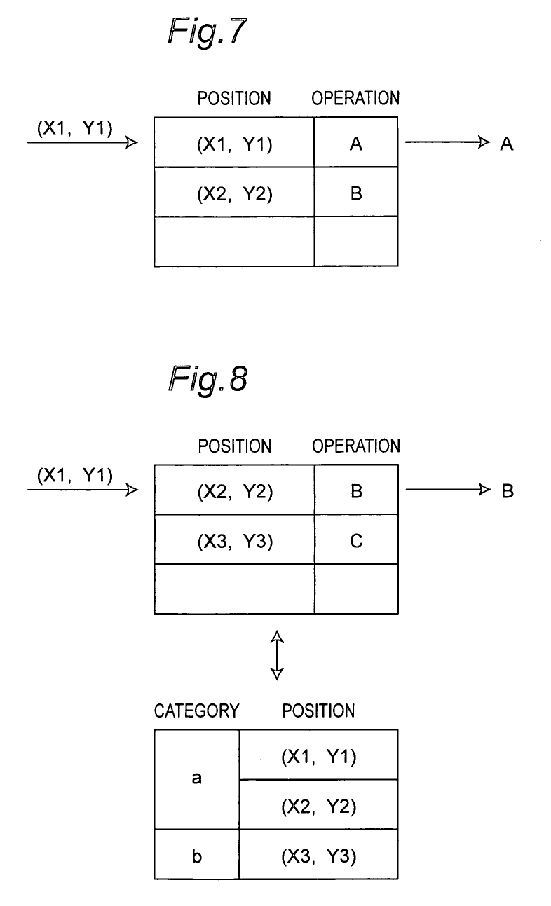

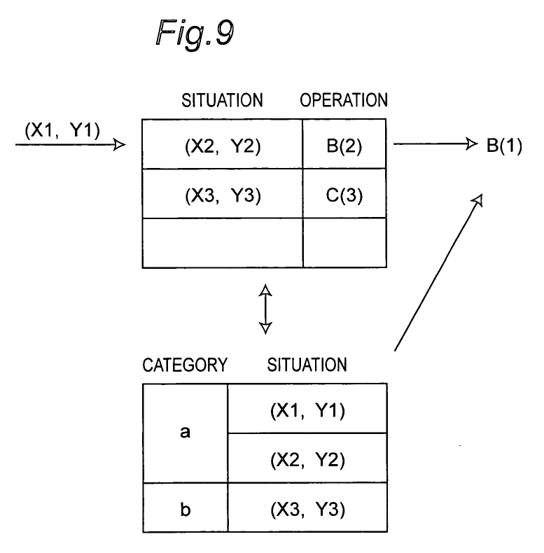

Next, differences in operation between the information processor shown in FIG. 12 and the information processor of the embodiment of the present invention will be described with reference to FIGS. 7 through 9. FIGS. 7 and 8 are diagrams simplistically showing operation examples of the information processor shown in FIG. 12, and FIG. 9 simplistically shows an operation example of the information processor according to the embodiment of the present invention.

FIG. 7 shows an example in which in the information processor shown in FIG. 12, position information (X1, Y1) has been acquired by the position acquiring section 11 and then the same position information has been found from the situation and operation storage section 13 as a result of position information comparison, so that operation A stored as the pair to the found stored position information is presented.

FIG. 8 shows an example in which position information (X1, Y1) has been acquired by the position acquiring section 11, but no same position information has been found from the situation and operation storage section 13 as a result of position information comparison, thus position information having the same category has been searched for, as a result of which position information (X2, Y2) matches the acquired position information for category “a”. Thus, operation B stored as the pair to the position information (X2, Y2) is presented.

On the other hand, FIG. 9 shows an example in which in the information processor shown in FIG. 1 of the embodiment of the present invention, position information (X1, Y1) has been acquired by the position acquiring section 1, but no same position information has been found from the situation and operation storage section 3 as a result of position information comparison, thus position information having the same category has been searched for, as a result of which position information (X2, Y2) matches the acquired position information for category “all. Then, operation B(2) stored as the pair to the position information (X2, Y2) is adapted to the current situation information into operation B(1), which is presented.

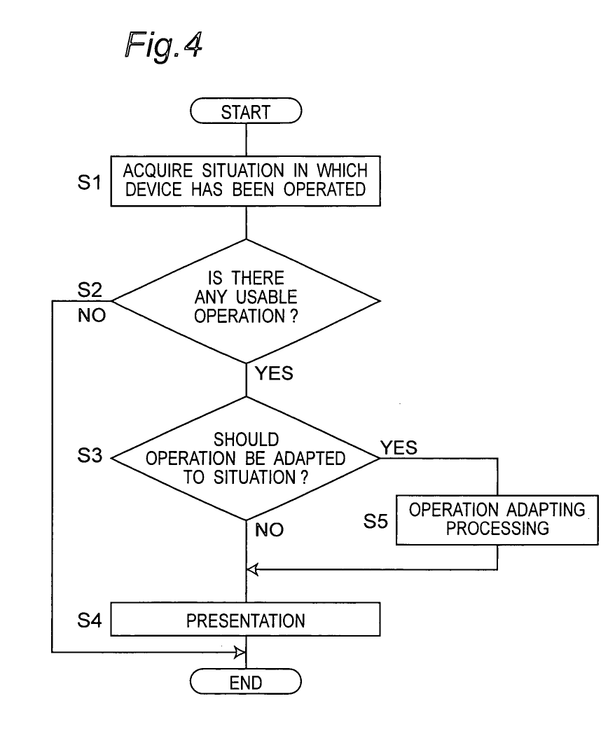

Next, the processing flow of the information processor according to the embodiment of the present invention will be described on the basis of the flow chart of FIG. 4.

First of all, the situation acquiring section 1 (shown in FIG. 1) acquires situation information such as a current time, place and so on (step S1).

Next, the situation comparing section 4 (shown in FIG. 1) compares the acquired situation information piece with situation information pieces stored in the situation and operation storage section 3 (shown in FIG. 1) to find an operation of which the situation information matches the acquired situation information (step S2). A method for determining whether there is a match will be described later.

When matching information exists, the situation comparing section 4 sends the operation information stored as the pair to the situation information in the situation and operation storage section 3 to the operation adapting section 6 (shown in FIG. 1). When no matching information has been found, the processing ends. The operation adapting section 6 determines whether or not to adapt the operation information delivered from the situation comparing section 4 to the situation information on the basis of the information in the situation hierarchy storage section 5 (shown in FIG. 1) (step S3). If it is determined that the adaptation is unnecessary, the operation information is sent to the presentation selecting section 7 (shown in FIG. 1) without being subjected to any processing. When it is determined that the adaptation is necessary, the operation adapting section 6 sends the operation information to the presentation selecting section 7 after performing the operation adapting processing (step S5). An operation adapting processing method will be described later.

The presentation selecting section 7 presents the operation information delivered from the operation adapting section 6 in a form understandable to the user (step S4), entrusting the user with decision whether to execute the operation.

Note here that every time some operation is executed in the operation section 2, situation information acquired then by the situation acquiring section 1 is stored pairing with the operation information into the situation and operation storage section 3.

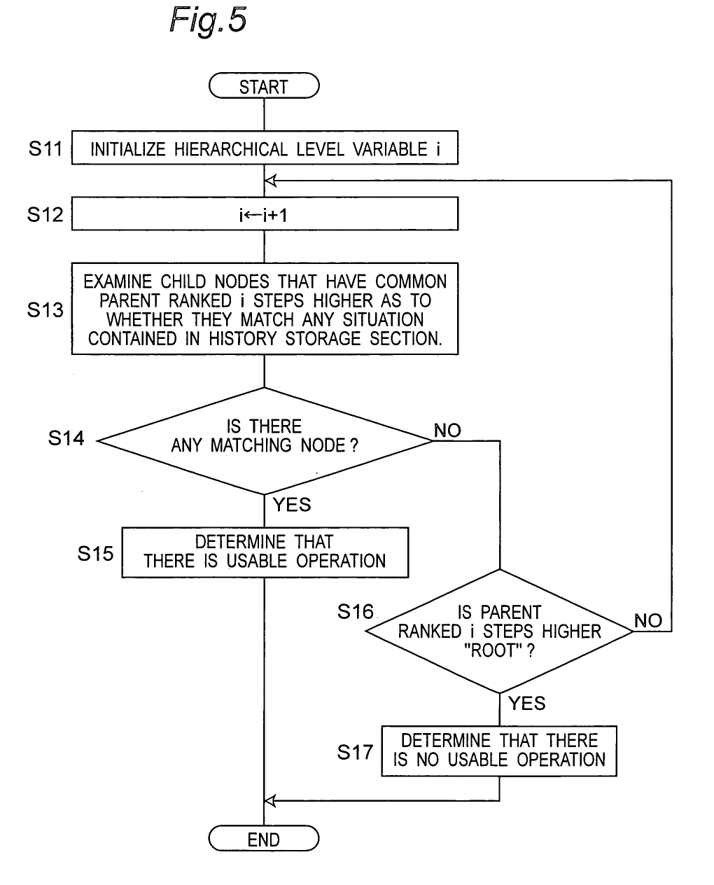

Next, a method by which the situation comparing section 4 searches the situation and operation storage section 3 for an operation of which an associated situation information piece matches the acquired situation information, by comparing the situation information pieces (S2 of FIG. 4) will be described referring to the flow chart of FIG. 5.

The hierarchical structure of situation information (places) as shown in FIG. 2 is stored in the situation hierarchy storage section 5 (shown in FIG. 1). It is assumed that situation information of being located at A station has been acquired by the situation acquiring section 1.

First, a variable i representing a hierarchical level is initialized (step S11). Next, the value of the variable i is incremented by one (step S12) and child nodes having a parent in common with the A station, which is ranked i levels higher as viewed from the A station, are examined as to whether they match some situation information stored in the situation and operation storage section 3 (step S13). In the example of FIG. 2, it is to be examined whether the B station is stored in the situation and operation storage section 3.

If there is a matching node (step S14), it is determined that a usable operation exists (step S15), and the processing ends. If there is no matching node, it is determined whether or not the parent ranked i levels higher is a root (step S16). It is determined that no usable operation exists if the parent is a root (step S17), and the processing ends. If the parent is not a root, the program flow returns to step S12.

Thus, by performing the above procedure, it can be determined whether or not the situation and operation storage section 3 contains an operation usable under the current situation.

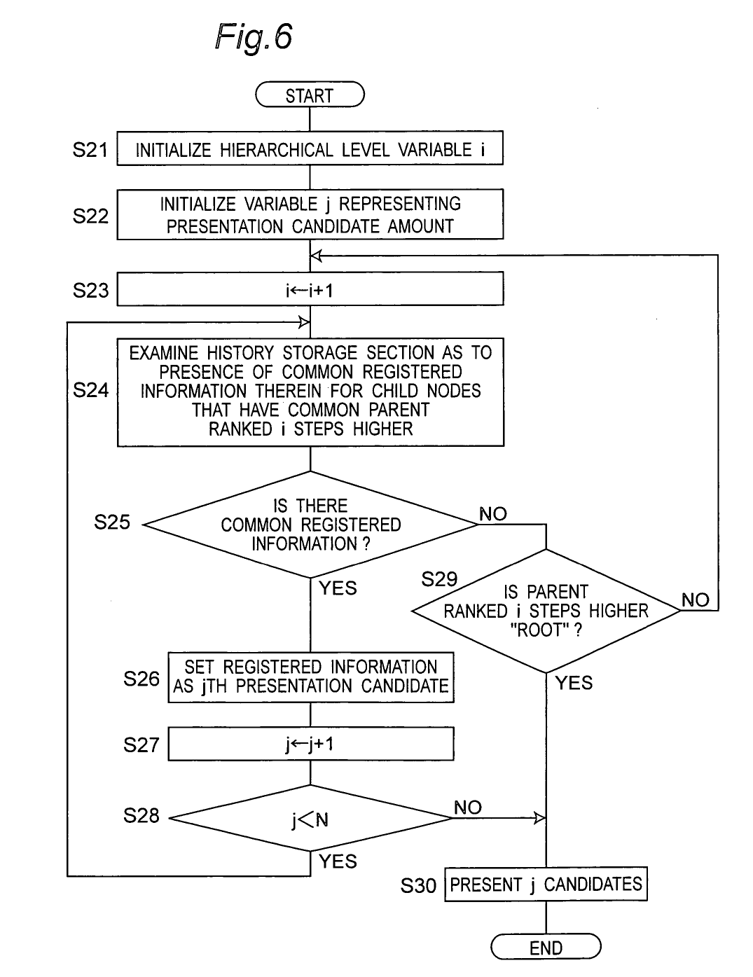

Next, a method for adapting the operation in the operation adapting section 6 (shown in FIG. 1) will be described referring to the flow chart of FIG. 6.

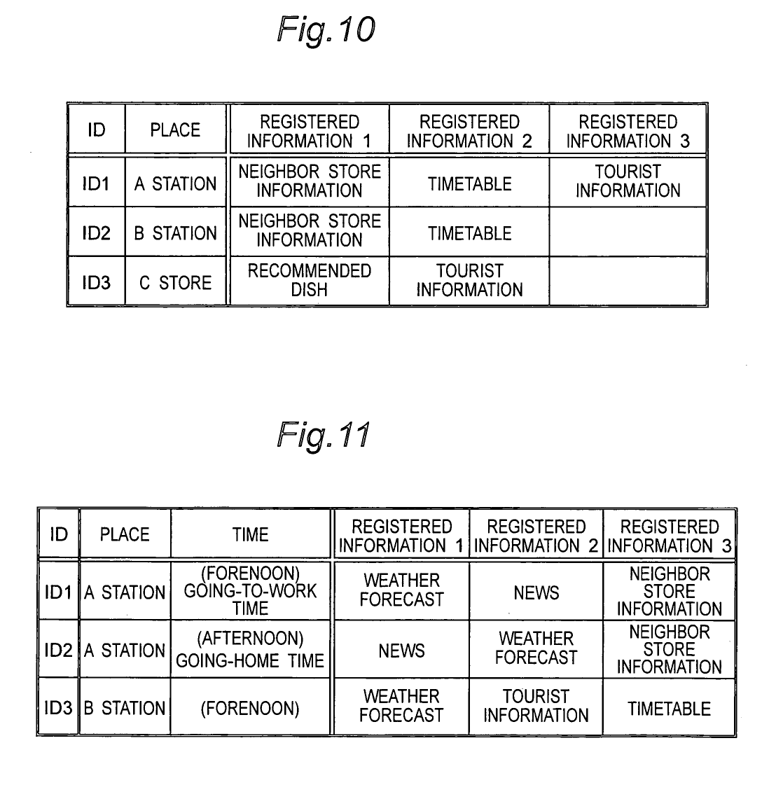

It is assumed that registered information as shown in FIG. 10 is stored in the operation adapting section 6. It is further assumed that the situation information of being located at the A station has been acquired by the situation acquiring section 1.

First, the hierarchical level variable i is initialized (step S21), and a variable j representing a presentation candidate amount is initialized (step S22) Next, the value of the variable i is incremented by one (step S23) and, regarding child nodes having a parent in common with the A station, which is ranked i levels higher as viewed from the A station, it is examined whether there is a common registered information piece in the situation and operation storage section 3 (step S24).

Because the situation information of being currently located at the A station has been acquired, it is to be examined whether or not the B station is stored in the situation and operation storage section 3 and whether or not the registered information of FIG. 10 includes a registered information piece common to the A station and the B station.

When the operation of seeing a timetable at the B station is stored in the situation and operation storage section 3, “timetable” is registered as registered information common to the A station and the B station. Therefore, it is determined in step S25 that there is common registered information.

When it is determined that there is common registered information, the content to be presented as the “timetable” differs between the A station and the B station although the registered information is the same, “timetable”. Therefore, the contents are adapted to the situation information, i.e., the content to be presented is a timetable for the B station, which is set as a jth presentation candidate (step S26).

Then, the value of j is incremented by one (step S27), and when the value of j is smaller than a predetermined upper limit value N (step S28), the program flow returns to step S24 to repeat the processing. If the value of j is not smaller than the upper limit value N, then j candidates are sent to the presentation selecting section 7 (step S30) and the processing ends.

If it is determined that there is no common registered information in step S25, it is determined whether or not the parent ranked i levels higher is a root (step S29). The program flow proceeds to step S30 when the parent ranked i levels higher is a root. Otherwise, the program flow proceeds to step S23.

By carrying out the above processing, the operation procedure can be adapted to a form corresponding to the situation in the operation adapting section 6. For example, it can be achieved that, when a person, who often sees the timetable at the A station, is located at the B station, the timetable of the B station is displayed substituting for the timetable of the A station on the basis of an operation of seeing the timetable of the A station performed at the A station in the past.

It is assumed that registered information as shown in FIG. 11 is stored as another example. Information shown FIG. 11 includes time information in addition to the registered information of FIG. 10. It is further assumed that the situation information of being located at the A station in the going-home time period has been acquired by the situation acquiring section 1.

If an operation of seeing a weather forecast at the A station in the going-to-work time period in the forenoon is held in the situation and operation storage section 3, it is determined in step S25 (shown in FIG. 6) that there is common registered information because the going-to-work time period and the going-home time period have a parent named the “commuting time period” in common as shown in the hierarchical diagram of FIG. 3, and “weather forecast” has been registered as common registered information of the A station.

Contents to be presented as weather forecast information should desirably be of the day if presented at the commuting time in the forenoon and, of the next day if presented at the going-home time in the afternoon. Therefore, if it is determined that there is common registered information, the stored contents are adapted to the situation information, i.e., the contents to be presented are made the weather forecast information of the next day, and this is set as a presentation candidate.

As described above, by storing in the form of a hierarchical structure and utilizing the situation information about the place, time and so on, it becomes possible to output information adapted to the situation. As a result, advantageously, chances to be able to take an appropriate response to the situation information are increased so that a user, who tends to perform a routine procedure under similar situations, can execute a desired procedure through a simple procedure without carrying out a plurality of troublesome operations.

Moreover, when the current situation information agrees with the broader concept of the situation information stored in the situation and operation storage section 3 as a result of the search of the situation hierarchy storage section 5, more appropriate management according to the situation information can be performed by executing the operation procedure according to the stored operation information through adaptation to the current situation information by the operation adapting section 6.

Moreover, the information processor according to the embodiment of the present invention has the communication section 8 as the communication means for communicating with any apparatus that has an IP (Internet Protocol) address, and acquires by the situation acquiring section 1 the IP address of a target apparatus for communications as a constituent element of the situation information via the communication section 8. That is, the IP address of the apparatus connected to the network is acquired as one element or piece of the situation information. For example, if the IP address of the apparatus of the connection destination is acquired and stored when hooking up to the Internet in a certain outdoor place, it becomes possible to determine the stored IP address as past situation information when hooking up to the Internet at the same place at another opportunity. With this arrangement, the information relevant to the place can be utilized even if a special device for acquiring the position information of GPS or the like is not utilized, and the desired operation, or the operation performed in the past can be executed by a simple procedure at the same place.

Moreover, when an IP address is allocated to the target apparatus for communications by a server, the allocated IP address might be varied depending on the day and situation of connection. If the IP address is varied, it is impossible to search for a matched one by comparison with the past IP address. Accordingly, when the IP address of an apparatus is allocated by the server, stored is not the allocated IP address of the apparatus but the IP address of the server that allocates the IP address to the apparatus. With this arrangement, it becomes possible to make determination of identity with a place in the past record even when the IP address allocated at the same place is varied.

Moreover, by providing the operation section 2 as the situation and operation inputting means, the user is allowed to specify information to be stored in the situation and operation storage section 3 as the situation and operation storage means.

It is to be noted that the functions of the information processor of the embodiment are achieved by an information processing program recorded in a program recording medium. Accordingly, it is also possible to provide such an information processing program in the form of a program product by recording the information processing program in a computer-readable recording medium.

The computer-readable recording medium may be a program medium constructed of a ROM (Read Only Memory). Otherwise, it may be a program medium that is to be loaded in an external auxiliary storage device and read thereby. In either case, a program reading means for reading the information processing program from the program medium may be configured to make direct access to the program medium or to load the program into a program storage area provided in a RAM (Random Access Memory) and make access to the program storage area. It is noted that a load program used for loading from the program medium into the program storage area of the RAM is preparatorily stored in a main unit.

The “program medium” herein is a medium that is constituted separable from the main unit and stationarily carries a program, inclusive of tapes such as magnetic tapes, cassette tapes and so on, magnetic disks such as flexible disks, hard disks and so on, optical disks such as CD-ROM (Compact Disc-Read Only Memory), MO (Magnet Optical disk), MD (Mini Disc), DVD (Digital Versatile Disc) and so on, cards such as IC (Integrated Circuit) cards, optical cards and so on, and semiconductor memories such as mask ROM, EPROM (Erasable Programmable Read Only Memory: ultraviolet erasable ROM), EEPROM (Electronically Erasable Programmable Read Only Memory: electrically erasable ROM), flash ROM and so on.

Moreover, when the information processor of the embodiment has a construction that includes a modem, a LAN card or the like and is connectable to a communication network including the Internet, the program medium may be a medium that fluidly carries a program by download from the communication network or the like. It is assumed that a download program for the download from the communication network in the case has preparatorily been stored in the main unit or installed from another recording medium.

The matter to be recorded in the recording medium is not limited only to the program, but allowed to be data.

The embodiment disclosed herein is only illustrative in every respect and not limitative. The scope of the present invention is not limited to the scope of the embodiment but is determined by the scope of the claims and includes all modifications and variations within the significance and scope equivalent to the scope of the claims.

The above description has been made about the embodiment in which the present invention is applied to an information processor. The present invention may also be applied to an information processing system including a server and a portable terminal communicating with the server.

For example, the portable terminal has a situation acquiring means for acquiring situation information about a situation in which an operation has been performed; a situation and operation storage means for storing the situation information acquired by the situation acquiring means and operation information about the operation performed then in an associated manner; a situation comparing means for comparing a current situation information piece with situation information pieces stored in the situation and operation storage means; an operation procedure executing means for executing an operation procedure according to an operation information piece stored in the situation and operation storage means on a basis of a result of the comparison by the situation comparing means; a situation hierarchy storage means for storing the situation information acquired by the situation acquiring means in a hierarchical structure; and a broader concept searching means for searching for a broader concept common to two situation information pieces compared by the situation comparing means on a basis of the situation information of the hierarchical structure stored in the situation hierarchy storage means. With this arrangement, opportunities to utilize past operations are increased, and the user, who has a routine to be performed under the same situation, can execute a desired operation through a simple procedure without carrying out a plurality of troublesome operations.

As is apparent from the above, in the information processor, portable terminal, information processing system, information processing method, information processing program and computer-readable recording medium of the present invention, the situation information and the operation information are stored in association with each other, and the operation that was performed under the past similar situation is executed by an easy method. The determination as to the similarity of the situations is made by storing situation information pieces as a hierarchical structure and examining whether or not the current situation information agrees with a stored situation information piece in the broader concept. Thus, opportunities to utilize past operations are increased, and the user, who is very likely to perform same things as a routine procedure under the same situation, can execute the desired operation through a simple procedure without carrying out a plurality of troublesome operations.

1. An information processor comprising:
a situation acquiring means for acquiring situation information about a situation in which an operation has been performed;
a situation and operation storage means for storing the situation information acquired by the situation acquiring means and operation information about the operation performed then in an associated manner;
a situation comparing means for comparing a current situation information piece with situation information pieces stored in the situation and operation storage means;
a situation hierarchy storage means for storing at least the situation information acquired by the situation acquiring means in a hierarchical structure;
a broader concept searching means for searching for a broader concept common to two situation information pieces compared by the situation comparing means on a basis of the situation information of the hierarchical structure stored in the situation hierarchy storage means;
an operation procedure executing means for executing an operation procedure according to an operation information piece stored in the situation and operation storage means on a basis of a result of the comparison by the situation comparing means and a result of the search by the broader concept searching means; and
an operation adapting means for adapting an operation procedure to be executed by the operation procedure executing means to a current situation when, as a result of the search by the broader concept searching means, a broader concept of a situation information piece on the current situation agrees with that of a situation information piece stored in the situation and operation storage means.

2. (canceled)

3. The information processor as claimed in claim 1, comprising:
a communication means for communicating with apparatuses that have their respective unique addresses, and
wherein the situation acquiring means acquires a unique address of an apparatus targeted for communications as a constituent element of the situation information via the communication means.

4. The information processor as claimed in claim 3, wherein,
when the unique address of the apparatus targeted for communications has been allocated by a server, the situation acquiring means acquires an IP address of the server via the communication means.

5. The information processor as claimed in claim 1, comprising:
a situation and operation inputting means for specifying, by a user, situation information and operation information to be stored in the situation and operation storage means.

6. A portable terminal comprising the information processor as claimed in claim 1.

7. An information processing system comprising a server and a portable terminal to communicate with the server, wherein
the portable terminal comprises:
a situation acquiring means for acquiring situation information about a situation in which an operation has been performed;
a situation and operation storage means for storing the situation information acquired by the situation acquiring means and operation information about the operation performed then in an associated manner; and
a situation comparing means for comparing a current situation information piece with situation information pieces stored in the situation and operation storage means,
the server comprises:
a situation hierarchy storage means for storing the situation information acquired by the situation acquiring means in a hierarchical structure; and
a broader concept searching means for searching for a broader concept common to two situation information pieces compared by the situation comparing means on a basis of the situation information of the hierarchical structure stored in the situation hierarchy storage means, and
the portable terminal further comprises:
an operation procedure executing means for executing an operation procedure according to an operation information piece stored in the situation and operation storage means on a basis of a result of the comparison by the situation comparing means and a result of the search by the broader concept searching means; and
an operation adapting means for adapting an operation procedure to be executed by the operation procedure executing means to a current situation when, as a result of the search by the broader concept searching means, a broader concept of a situation information piece on the current situation agrees with that of a situation information piece stored in the situation and operation storages means.

8. An information processing method comprising:
a situation acquiring step of acquiring a situation information piece about a situation in which an operation has been performed;
a situation and operation storage step of storing the situation information piece acquired in the situation acquiring step and an operation information piece about the operation performed in an associated manner;
a situation comparing step of comparing a current situation information piece with situation information pieces stored in the situation and operation storage step;
a situation hierarchy storage step of storing the situation information pieces acquired by the situation acquiring means in a hierarchical structure;
a broader concept searching step of searching for a broader concept common to two situation information pieces compared in the situation comparing step on a basis of the situation information of the hierarchical structure stored in the situation hierarchy storage step;
an operation procedure executing step of executing an operation procedure according to an operation information piece stored in the situation and operation storage step on a basis of a result of the comparison done in the situation comparing step and a result of the search done in the broader concept searching step; and
an operation adapting step of adapting an operation procedure to be executed in the operation procedure executing step to a current situation when, as a result of the search in the broader concept searching step, a broader concept of a situation information piece on the current situation agrees with that of a situation information piece stored in the situation and operation storage step.

9. An information processing program for enabling a computer to execute the information processing method as claimed in claim 8.

10. A computer-readable recording medium containing the information processing program as claimed in claim 9.
